(19) United States
(12) Patent Application Publication
(10) Pub. No.: US 2014/0129725 A1
(43) Pub. Date: May 8, 2014

(54) SmartLight Interaction System

(71) Applicant: Panasonic Corporation of North America, Secaucus, NJ (US)

(72) Inventors: Jean-Claude Junqua, Saratoga, CA (US); Ricardo Teixeira, San Jose, CA (US); David Kryze, Campbell, CA (US)

(73) Assignee: Panasonic Corporation of North America, Secaucus, NJ (US)

(21) Appl. No.: 14/071,691

(22) Filed: Nov. 5, 2013

Related U.S. Application Data
(63) Continuation-in-part of application No. 14/070,769, filed on Nov. 4, 2013.
(60) Provisional application No. 61/723,652, filed on Nov. 7, 2012.

(51) Int. Cl. H04L 29/06

(52) U.S. Cl. CPC H04L 65/1069
USPC 709/227

(57) ABSTRACT

The interfacing computer system mediates connections between user devices and peripheral devices. The system includes a platform server computer having an input/output port that supports communication with a plurality of devices using the IP protocol. The platform server computer is programmed to provide a peripheral device registration function whereby information about a peripheral device is stored in the associated memory. The platform server computer is further programmed to provide a user device authentication function whereby information about a user device is stored in the associated memory and accessed by the at least one processor to mediate how a registered peripheral device may be accessed by said user device. The platform server computer also provides an information routing function whereby source information originating from a first device is routed through the input/output port to a device other than the first device and according to instructions provided to the platform server computer by a user device.

### CROSS-REFERENCE TO RELATED APPLICATIONS

This application is a continuation-in-part of U.S. patent application Ser. No. 14/070,769, filed on Nov. 4, 2013, which claims the benefit of U.S. Provisional Application No. 61/723,652, filed on Nov. 7, 2012. The entire disclosure of each of the above applications is incorporated herein by reference.

### FIELD OF THE DISCLOSURE

This disclosure relates generally to conference room automation systems and more particularly to a server-based platform employing common protocol, such as IP protocol, to allow a variety of different peripheral devices to be captured and used on an ad hoc basis by participants within the conference room.

### BACKGROUND

This section provides background information related to the present disclosure which is not necessarily prior art.

According to several recent surveys, the typical office worker spends over five hours per week attending meetings. Most managers spend well over twice that. To make matters worse, these surveys show that over half of the time meetings are conducted without a prepared agenda. Equipment is poor and contributes to the inefficiency. Peripheral equipment such as conference room projectors must be shared, where each user brings his or her portable device or laptop and then takes turns using the projector, plugging and unplugging with every change in presenter. Conference rooms are frequently scheduled but then not used. Valuable time and resources are thus wasted. Moreover, even when the meeting is successful, there is often no simple way of capturing notes of the meeting that can be usefully shared among the group.

### SUMMARY

This section provides a general summary of the disclosure, and is not a comprehensive disclosure of its full scope or all of its features.

The disclosed system seeks to improve the conference room experience, making peripheral devices easier to use and to share, as well as making resource scheduling more reliable. The disclosed system accomplishes this through an integrated, platform server system that mediates connection between user devices and peripheral devices, where users can capture peripheral devices on an ad hoc basis using a personal device such as a laptop, smartphone or tablet computer. Peripheral devices all share a common protocol, without losing any of their legacy capability. Room reservations are handled in the same way. Occupancy sensors communicate through the platform server to calendar systems, to provide those systems with real-time information on how a scheduled conference room is being used. Peripheral devices may also be shared between several user devices. For example, several laptops can share a display or a projector screen. The screen would be divided into a number of images, each coming from different laptops.

In accordance with one aspect, the interfacing computer system comprises a platform server computer having an input/output port that supports communication with a plurality of devices using a predefined protocol, such as the IP protocol, and having at least one processor with associated memory. The platform server computer is programmed to provide a peripheral device registration function, whereby information about a peripheral device is stored in the associated memory. The platform server computer is further programmed to provide a user device authentication function, whereby information about a user device is stored in the associated memory and accessed by the at least one processor to mediate how a registered peripheral device may be accessed by said user device. Additionally, the platform server computer is programmed to provide an information routing function, whereby source information originating from a first device is routed through the input/output port to a device other than the first device and according to instructions provided to the platform server computer by a user device.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a block diagram of an exemplary system to mediate connections between user devices and peripheral devices.

FIG. 2 is a block diagram of a smart peripheral device architecture.

FIG. 3 is an electronic circuit diagram of the smart core module of a smart peripheral device.

FIG. 4 is an exemplary smart peripheral device, namely, an image projector for displaying slide presentations and video presentations in a meeting room or conference room.

FIG. 5 is an exemplary smart peripheral device, namely, a room lighting circuit that includes an embedded smart core module to allow the room lights to be controlled via the platform server.

FIG. 6 is an exemplary smart peripheral device, namely, a room occupancy sensor that reports occupancy to a reservation or calendar system.

FIG. 7 illustrate two exemplary smart peripheral devices, namely, a whiteboard data capture device and a video camera device, each equipped with smart core modules to communicate with the platform server.

FIG. 8 is a block diagram of the architecture of the platform server, specifically illustrating the database schema.

FIG. 9 is a block diagram of the architecture of the platform server, specifically illustrating the protocol conversion and transcoder circuits.

FIG. 10 is a block diagram of the architecture of the platform server, specifically illustrating the optical character recognition, speech recognizer and associated circuitry for adding metadata tags to captured audio and video.

FIG. 11 is a block diagram illustrating how the platform server is configured to support multiple user devices capturing and sharing a single smart peripheral device, in this case a flat panel digital display monitor.

Corresponding reference numerals indicate corresponding parts throughout the several views of the drawings.

### DESCRIPTION OF PREFERRED EMBODIMENTS

Example embodiments will now be described more fully with reference to the accompanying drawings.

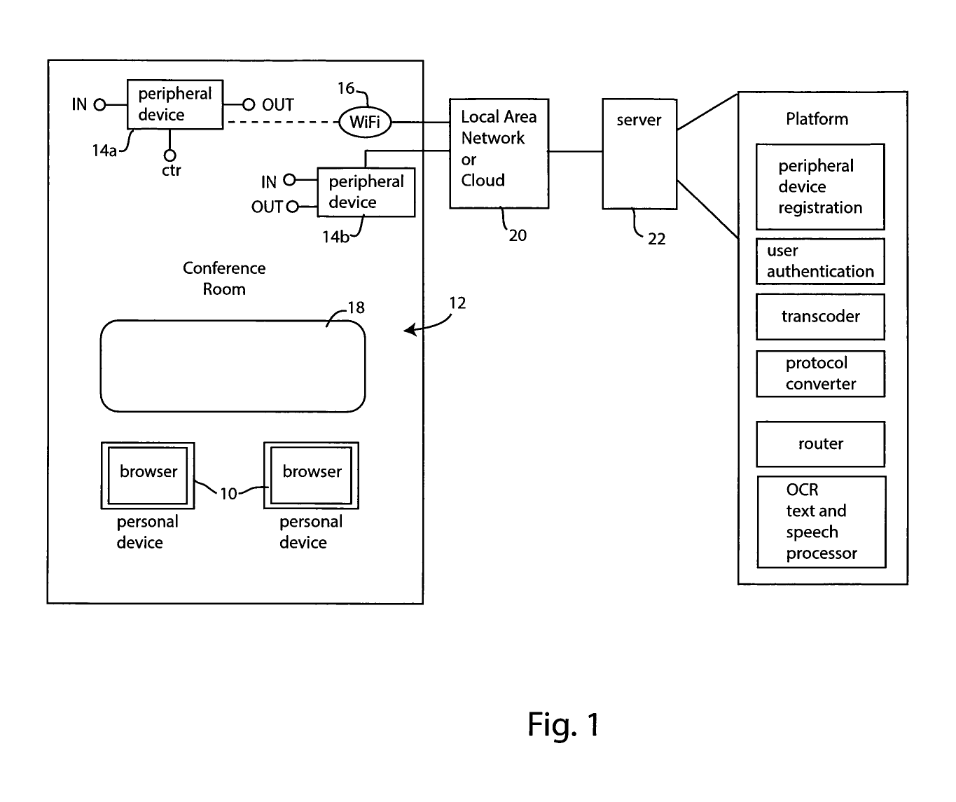

Referring to FIG. 1, a server-based interfacing computer system to mediate connections between user devices 10 and peripheral devices has been illustrated. In the illustrated example, the user devices 10 may be any of a variety of different mobile personal devices, such as laptop computers, tablet computers, smartphones, smart wearable devices and the like; or the user devices may be dedicated computer devices fixedly situated in the conference room 12. These user devices are programmed with suitable browser software, such as Microsoft Internet Explorer, Google Chrome, Apple Safari, FireFox, or the like, and are able to communicate with a local area network or Internet-based cloud computer resource, shown generally at 20.

Situated in the conference room 12 are a plurality of smart peripheral devices, such as devices 14a and 14b. These devices each have at least one input (IN), and at least one output (OUT), and in some cases an additional control port (ctr). The smart peripheral devices are connected to the local area network or Internet-based cloud computer resource either by hardwired (e.g., Ethernet) connection or wirelessly (e.g., WiFi or cellular connection). A WiFi access point 16, coupled to local area network or cloud computer resource 20, has been illustrated by way of example.

The server-based interfacing computer system supports a variety of different smart peripheral devices that serve different functions within the conference room. A non-exhaustive list of such devices includes:

1. projector for display of slideshow presentations, video movie clips, informational messages, meeting room calendars, and the like;

2. robotic mounting arm for projector, allowing the projector to be pointed in different directions, such as onto different walls within the conference room or downwardly onto a horizontal surface such as a conference table 18;

3. room lighting, including overhead lighting for general illumination, task lighting, robotically controlled directional lighting;

4. flat panel monitor for display of audio/video content;

5. cameras for capturing information displayed during a meeting within the conference room, including both still-image cameras, 3D cameras, digital video cameras, and the like;

6. audio systems for playback of audio material into the conference room;

7. microphone systems for capturing sounds within the conference room, including verbal presentations and discussions during a meeting; and

8. room presence sensors for detecting whether the conference room is occupied, and tracking number and location of room occupants.

Connected to the local area network or internet-based cloud service is a platform server computer 22. The platform server computer 22 is specially programmed to provide a plurality of interfacing services used to mediate connections between the user devices 10 and the peripheral devices 14a, 14b. Among the interfacing services provided are the following:

1. peripheral device registration whereby a database record is maintained in the platform server of each peripheral device and its location and interfacing input, output and control requirements, and including the usage state of each device (whether it has currently been captured for use and by which user device);

2. user authentication whereby a record is maintained in the platform server of each user device, including authentication credentials such as user ID, device ID and password, including which peripheral devices a user is permitted to access;

3. signal transcoding whereby a signal carrying user-originated content is converted into a signal format that is suitable to the peripheral device captured by the user device;

4. protocol converting whereby control signals and communications protocols are converted from the protocols used by the user device into the protocols required by the peripheral device, and vice versa;

5. user-originated content signal and control signal routing, whereby content and control signals issued by the user device are routed to the smart peripheral device captured by the user device; and

6. optical character recognition (OCR), text and speech processing services to convert optically presented text and spoken content into machine-readable text that can then be indexed and searched for database storage and retrieval.

A key aspect of the platform server is to associate the inputs (including control inputs) and outputs of the peripheral devices with the various user devices for use in supporting various conference room functions. By way of example, the platform server allows a user to authenticate his or her user device via the browser and then capture a peripheral device for use by that user device, on an ad hoc basis. During a meeting, a user might thus capture a projector, use that projector to display a slide presentation being run on the user device and then release the projector so that a different user can capture and use it. The user might also, using the same browser connected to the platform server computer 22, take control of the room lights, changing them to a more suitable illumination for the presentation. Essentially any smart peripheral device may be controlled in this fashion. The platform server presents a unified browser interface to the user's personal device and also handles all of the signal processing and routing. By separating inputs from outputs, the user's personal device does not need to be preprogrammed with protocols required by the smart peripheral device. The platform server handles those details.

The smart peripheral devices are preferably designed to receive user-originated content signals and control signals directly from the platform server computer. Thus in one embodiment each smart peripheral device includes an embedded platform communication engine that provides the device with the correct communications protocols to interact with the platform server. Alternatively, the platform server may be configured to auto-discover the protocols used by the peripheral device and adapt its output to match that of the peripheral device.

### Design of Smart Peripheral Device

Smart peripheral devices may be adapted to a wide variety of different functions and purposes. For example, some smart devices are designed to provide information to participants in the conference room or meeting room. Other smart devices are designed to control other devices, either situated in the conference room or meeting room, or located elsewhere. Still other smart devices are designed to capture information from within the conference or meeting room. Examples of each of these will be provided here, and it will be understood that the concepts described here may be extended to other types of devices and for other purposes.

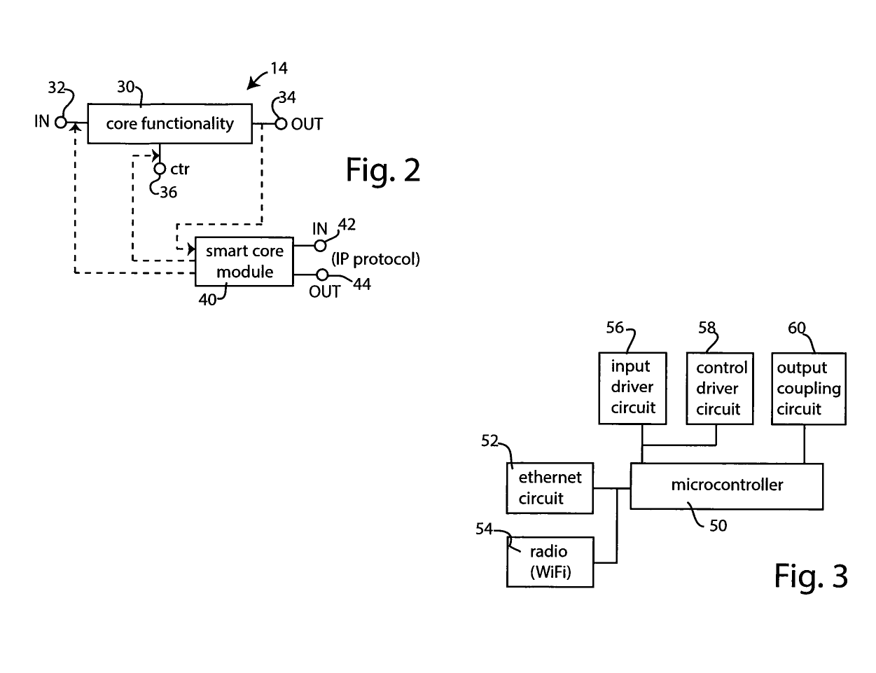

Thus each smart peripheral device has its own core functionality, with inputs and outputs as required. Each smart peripheral device also has a smart core module that allows the device to interact with the platform server computer. The basic architecture of a smart peripheral device 14 is shown in FIG. 2. The device includes the electronic circuitry to support the core functionality of the device, shown at 30. This electronic circuitry may have its own inputs, outputs and control ports by which the device would be used when the smart peripheral device capability is not being used. These ports are designated at 32, 34 and 36, respectively. For example, if the core functionality is a VGA projector, the input port 32 would typically be a VGA input port, the output would supply RGB data to an LCD device, for example, that converts a high intensity beam of light into a pattern of colors according to the image content supplied through the input port. The control port of such VGA projector would be designed to receive data signals derived from pushbutton controls on the device or from a remote control.

Supplementing the standard inputs, outputs and control ports, the smart peripheral device 14 further includes a smart core module 40 which is implemented as an electric circuit coupled to the input, output and control ports 32, 34 and 36, as illustrated. The smart core module also includes its own input and output ports 42 and 44 that communicate using a predefined protocol, such as the Internet Protocol (IP). By using the IP protocol, the input and output ports 42 and 44 are able to connect with and communicate with an Ethernet-based or wireless local area network, and also with Internet-based cloud services.

### Smart Core Module

FIG. 3 shows an embodiment of the smart core module 40 electronic circuitry in greater detail. The smart core module is based on a microcontroller integrated circuit 50, which includes a processor, embedded random access memory (RAM) and read only memory (ROM). A suitable microcontroller may be implemented using an 8051 integrated circuit available from Intel. Attached to the microcontroller 50 is an Ethernet communication circuit 52 that in turn communicates with ports 42 and 44 of the smart peripheral device 14. For example, an Ethernet controller such as the ENC28J60 available from Microchip, or RTL8109 available from Realtek, or the like, may be used. If desired, the smart core module 40 may also include a radio circuit 54 to support WiFi communication with an access point 16 (FIG. 1).

Also attached to the inputs and outputs of microcontroller 50 are the input driver circuit 56 to provide a buffered connection to the corresponding input 32 of the smart peripheral device itself. A similar buffered connection circuit 58 provides connectivity to the control input (if present) on input 36 of the smart peripheral device. Finally, a buffered output coupling circuit 60 provides connectivity between the microcontroller 50 and the output port 34 of the smart peripheral device.

### Devices Providing Information to Participants

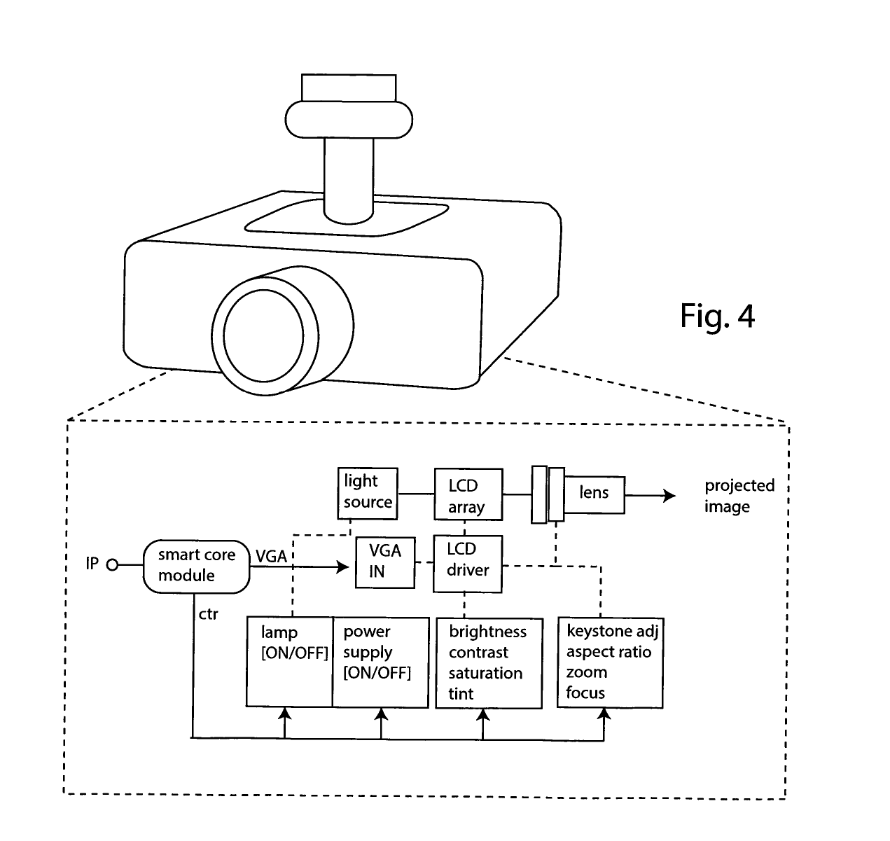

Shown in FIG. 4 is a projector with smart core module embedded therein, exemplifying a device that provides information to participants within a conference room or meeting room. The projector uses an LCD element to convert a high intensity white light into a projected image. In this case, the projector operates using a digital input signal. The projector is mounted on a robotic arm that may be controlled by control signals from the smart core module to point the projector in any desired direction based on commands from a user sent via the platform server. If desired, the projector can be suspended on the robotic arm from the ceiling within the conference room or meeting room.

Digital signals carrying the content to be projected are received as data packets over IP protocol via the input port 42 of the smart core module 40 embedded in the projector. The microcontroller within the smart core module extracts the digital content from the IP data packets received and packages that content into an HDMI protocol digital video signal which is then coupled to the input port 32 of the projector.

While the digital content can originate from a variety of different sources, for this example, the digital content originates from a user's laptop, which is connected via WiFi access point 16 to the local area network 20 and ultimately received by the platform server. In this exemplary embodiment, the user may be running a PowerPoint slide presentation on the user's laptop. Screen capture software delivered from the platform server and installed on the user's laptop captures screen images of the slide presentation and sends those images to the platform server. Exemplary Java code to perform this function has been provided in the Appendix below.

It bears noting that the user's laptop does not need to establish direct connection to the projector. Thus there is no need for the laptop to convert the slide presentation into HDMI protocol for the projector to use. Also, it is not necessary for the PowerPoint slide presentation software to be running on the platform server or on the projector, as the screen capture software extracts the visible content as it is rendered on the screen of the user's laptop.

The platform server accesses its internal database and learns the protocol being used by the projector. This information is stored in the platform server's database during prior device registration. Thus when a user authenticates his personal device (e.g., laptop) and requests to “capture” the projector in his conference room, the platform server looks up the protocol used by that projector and formulates the data received from the screen capture software into a format needed by the projector (e.g., HDMI). The platform server then encodes this converted HDMI data as IP data packets and sends them to the smart core module 40 of the projector.

### Devices Controlling Other Devices in the Room

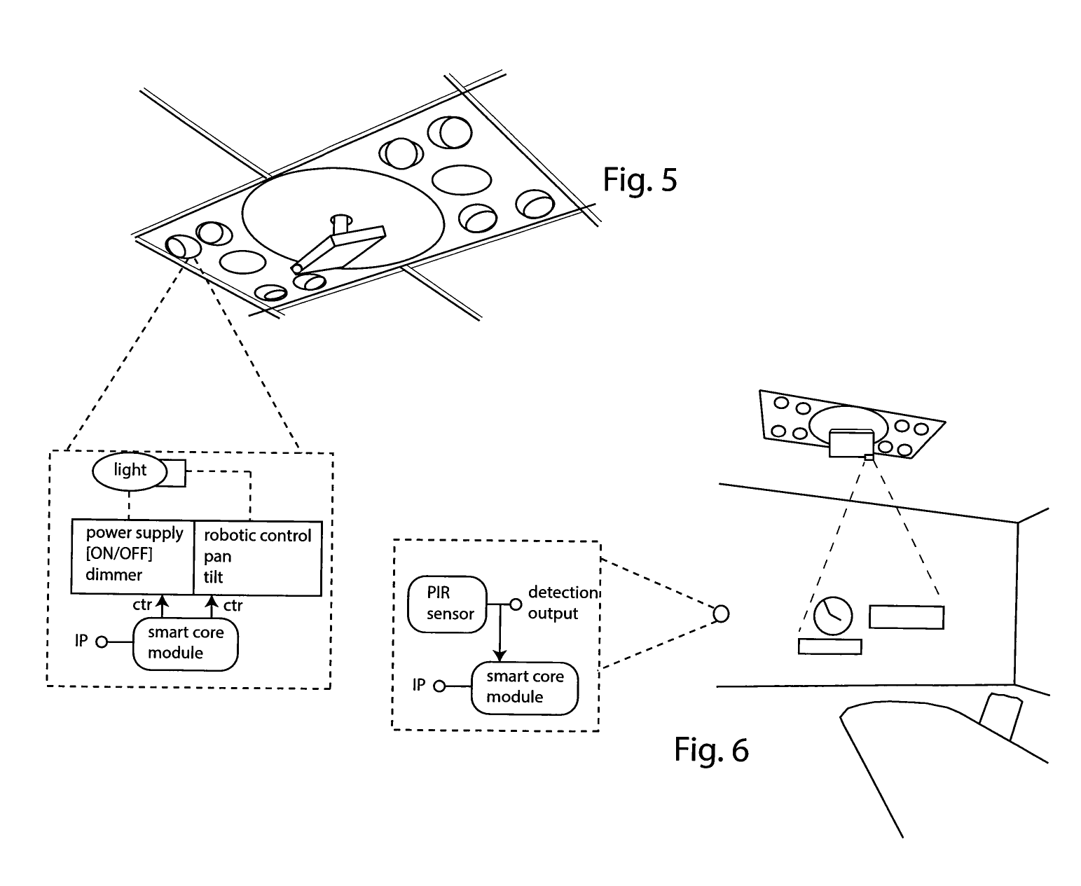

By way of further example, FIG. 5 shows a room lighting circuit that includes an embedded smart core module to allow the room lights to be controlled via the platform server. In this case, the core functionality of the room lighting circuit requires the ability to turn on, turn off, and dim the lights. Signals to accomplish these tasks are sent via the control input 36 of the lighting circuit. Thus the embedded smart core module does not require connection to input or output ports of the lighting circuit (as there would not normally be such ports). If desired, however, the lighting circuit can include a light sensor positioned to detect the illumination coming from the light emitter of the lighting circuit. The output of this light sensor can be fed back as an “output” of the lighting circuit to the smart core module 40, allowing the microcontroller of the smart core module to detect if the light emitter is burned out. Upon such detection, the smart core module communicates the illumination state via IP protocol message to the platform server.

This same light emitter signal can also be used to detect if the room lights are on, allowing a remotely-located room scheduling application (e.g., calendar application) to acquire information on whether the room lights are on. Such signal may be used as an indication that the room is in use; alternatively, such signal can be compared with the room reservation calendar, allowing a custodial person to turn off the lights (by visiting the room or remotely via the platform server) to save energy if the room is not actually in use.

Devices Interacting with Systems Located Elsewhere

Alluded to in the previous example, the system can be used to interact with systems located outside the conference room or meeting room. By way of example, in an office complex with many conference rooms scheduled on a daily basis, a calendar application may be used to track which conference room resources are needed and when. Typically, such a calendar system is run on a server, attached to the local area network 20, and accessible to all employees of a company. Users invite other company members to a scheduled meeting using the calendar application, and use the same application to reserve a selected conference room for a predetermined time slot.

The conventional calendar application has no awareness of whether a scheduled conference room is actually in use. It is not uncommon for a meeting to be scheduled and then postponed or cancelled, without making proper indication in the calendar system that the reserved conference room has been freed up for someone else to use. To address this, shown in FIG. 6, a smart peripheral device in the form of a room occupancy sensor may be added to each conference room. The core functionality of the occupancy sensor is simply to detect presence of animate objects within the room and report when room occupancy has been detected. Such occupancy sensor functionality may be accomplished using passive infrared (PIR) sensors, ultrasonic sensors, microwave sensors, tomographic motion detectors, and the like.

The embedded smart core module 40 within the sensor is coupled to the output port 34 of the sensor and is processed by the microcontroller within the smart core module, whereby the occupancy state of the room is converted into a data signal that can be read upon interrogation via the output port 44 using IP protocol. When queried by the calendar application via the platform server, the occupancy state of the room is reported via IP protocol by the microcontroller of the smart core module. Alternatively, the occupancy state of the room can be pushed to the platform server in real time, as the room occupancy state changes, and the platform server maintains a record for access by the calendar application.

Devices Capturing Information from within the Room

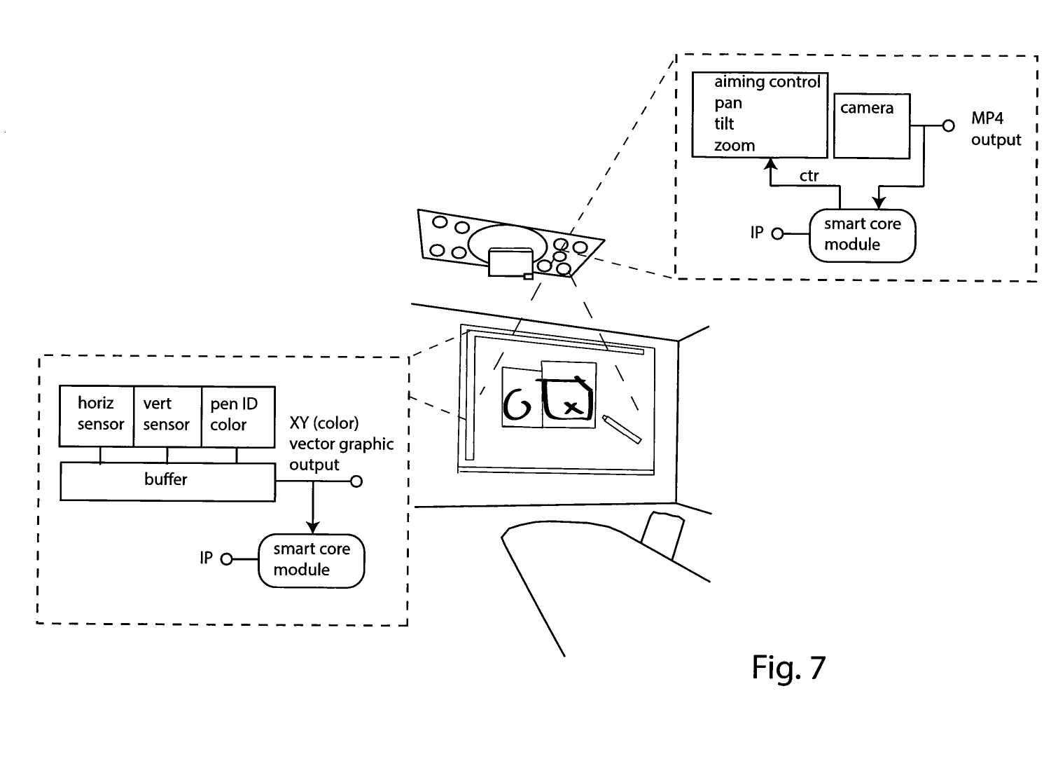

Shown in FIG. 7, two smart peripheral devices are illustrated for capturing information from within the room, such as during a presentation. The first device is a data capture whiteboard having sensors that track position and movement of a dry erase marker as it is used to draw annotations on the whiteboard screen. The second device is a video camera, mounted in the room, such as on a robotic arm similar to that shown in FIG. 4. The video camera captures information on the whiteboard screen surface, which may include not only annotations drawn by the presenter using a marker, but also information projected onto the screen by a projector such as the one featured in FIG. 4.

The whiteboard sensors and the video camera each have embedded smart core modules that communicate via IP protocol with the platform server. The platform server may include optical character recognition (OCR) processing software by which textual annotations captured by the respective whiteboard sensors and camera systems are converted into machine-readable text. This allows the information captured and reported to the platform server to be indexed and stored in an organized fashion in the database of the platform server. By storing captured text in association with the captured video content, a user can access the platform server and conduct a keyword search in order to retrieve the saved captured video content.

### Design of Platform Server

The platform server is configured to provide the functionality depicted in FIG. 1, where each of the depicted functions are programmed as separate modules or program routines which will now be individually described.

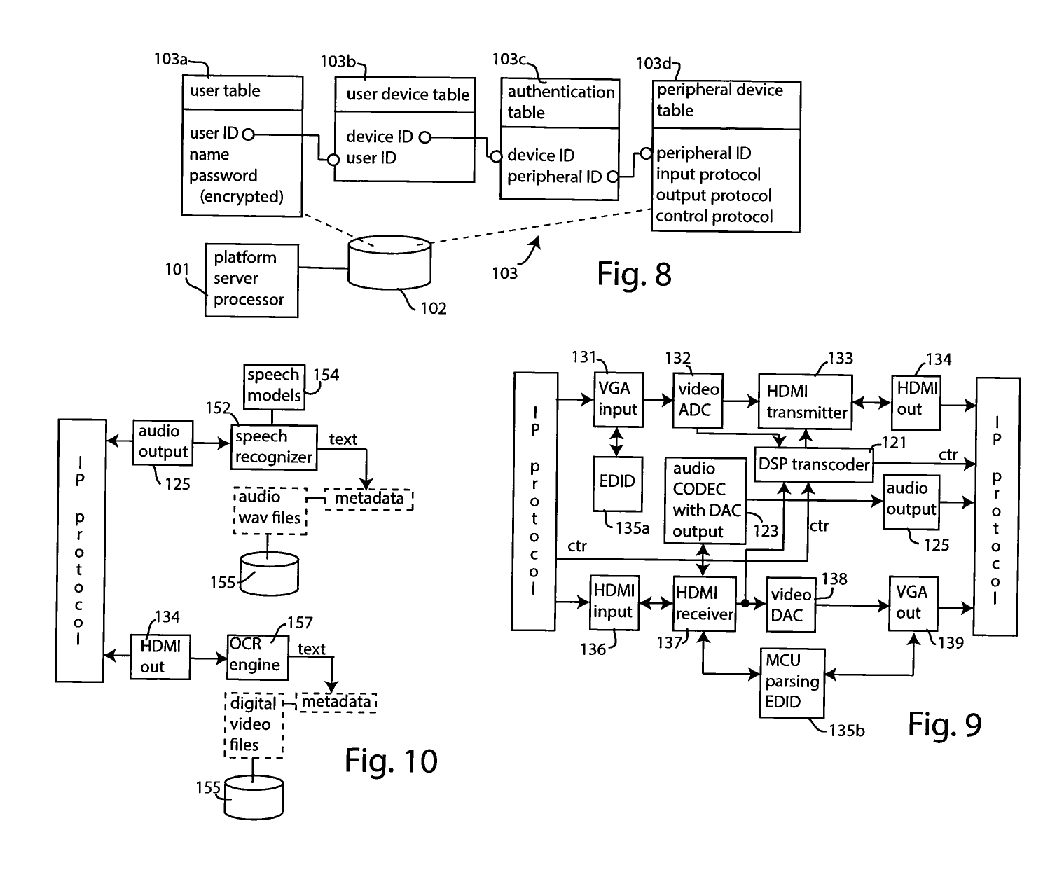

Referring now to FIG. 8, the peripheral device registration function 100 is implemented by a relational database 102 running on the processor 101 of the platform server 22 (FIG. 1). The relational database may be implemented using commercially available database management system software, such as MySQL, Microsoft SQL Server, Oracle, or the like. An exemplary database schema is illustrated in FIG. 8 at 103. Note that device registration and user authentication (discussed next) are implemented using the same relational database, via different tables, as defined by the schema 103. Data maintained by the relational database are stored in a suitable storage device attached to the platform server where it can be accessed by the processor 101 of the platform server.

As illustrated, the database schema includes a user table 103a linked by user ID to a user device table 103b. The device table maintains a separate record of each device the user has configured to use to interact with the platform server. The schema also includes a peripheral device table 103d that stores individual records for each smart peripheral device administered by the platform server. A linking table, the authentication table 103c, links registered user devices with peripheral devices. Records in this table reflect which device or devices have been captured by a particular user device.

The processor 101 of the platform server populates the peripheral device table 103d with the identified information about each peripheral device that is registered to work with the system. Typically, such registration is performed by an operator of the platform server and will only need to be performed once, as each new device is added to the ensemble of devices within the conference room. Companies with many conference rooms will populate the database with information about all smart peripheral devices within that company's control.

The user authentication function 110 (FIG. 1) is also supported by the relational database 101. Specifically, the user table 103a is populated by the processor 101 with information about each user, nominally storing a user ID and password that is queried when the user logs onto the platform server. Similarly, the user device table 103b is populated with information about each user device that is authorized to capture and use smart peripheral devices. Note that the user device table is relationally linked with the peripheral device table 103d through the intermediate authentication table 103c. This intermediate table allows one user to capture and use multiple devices at the same time, if desired; and also allows a single device to be used by multiple user devices, if desired.

In an alternate embodiment, authentication may be implemented using a rolling code session number. When the user wishes to capture a device, the user accesses the web site generated by the platform computer and enters a session number provided by the platform computer and made visible to users in the conference room, such as by projecting the generated number on a display within the room. The platform computer changes the session number periodically, such as every 60 seconds. The user must enter the displayed session number in order to authenticate to the system. Thus the authentication system prevents a person who is not in the room from capturing or connecting to the device.

The signal transcoding functions 120 (FIG. 1) and protocol converter functions 130 (FIG. 1) are also supported by the processor 101 of the platform server. In this regard, FIG. 9 shows the electronic circuitry used to convert between VGA analog and HDMI video signals as would be used by camera devices, projector devices and display devices. As illustrated, this protocol converter and transcoder circuitry is sandwiched between the IP protocol layers. In other words, all communication into and out of this protocol converter circuitry and transcoder circuitry is handled using the IP protocol.

A VGA input at 131 is converted to digital data using the video analog-to-digital converter 132, then formatted into an HDMI data signal in the HDMI transmitter circuit 133, and then output to the HDMI output buffer 134. Timing data for converting VGA into HDMI are provided by the extended display identification data (EDID) 135a stored in memory associated with processor 101. The VGA source reads the EDID content to obtain the timing data.

To convert HDMI into VGA analog, further electronic circuitry is provided. The HDMI input 136 is fed to the HDMI receiver circuit 137 and then converted into an analog signal by the video digital-to-analog converter (DAC) 138 before it is sent to the VGA output circuit 139. The EDID data is parsed by the MCU parsing circuit 135b to provide proper EDID content for the HDMI source.

Suitable circuitry to implement the described VGA-to-HDMI and HDMI-to-VGA protocol conversions may be based on commercially available integrated circuits, such as the AD9983A and ADV713 (VGA to HDMI) and the ADV7611 and ADV7125 (HDMI to VGA) available from Analog Devices.

The transcoding function 120 (FIG. 1) may also be implemented in electronic circuitry shown in FIG. 9. In the illustrated embodiment, transcoding is performed in the digital domain. Thus signals in one digital format are converted into signals of a different format. This is done using a digital signal processing (DSP) integrated circuit, or DSP transcoder 121 that communicates with the digital data bus to which the HDMI transmitter 133 and HDMI receiver 137 are attached. Of course, if desired, analog-to-analog transcoding may also be effected. User-originated control signals that require conversion or logic functions applied to them are also handled by the DSP transcoder. Note that the circuit of FIG. 9 includes at least one audio CODEC 123 stored in memory attached to processor 101. This CODEC is used to extract audio from the HDMI signal, which is then stored in audio output buffer 125.

FIG. 10 shows further circuitry of the platform server to handle the OCR text and speech processing functions 150 (FIG. 1). The audio output buffer 125 (also shown in FIG. 9) supplies data to the speech recognizer 152, which is preferably a Hidden Markov Model (HMM) recognizer based on a set of stored speech models 154 contained in the memory attached to processor 101. The speech recognizer generates alphanumeric text from the recognized digital audio speech content. This text data is then appended to audio way files (digital audio files) of speech captured during a presentation, for example. These audio files and attached metadata are stored in a database 155 administered by processor 101 or, alternatively, a co-located database deployed elsewhere by an Internet-based cloud service. By attaching or tagging text metadata to specific frames of digital audio (or audio-video) content, a user can perform a keyword search of text terms, and the database will retrieve recorded audio or audio-video content that contains those keyword terms.

In a similar manner, the HDMI output buffer 134 (also shown in FIG. 9) supplies video content to the OCR engine 157 operated by the server processor 101. Optical character recognition is performed across content captured by a camera or whiteboard data capture device and the captured images are converted into alphanumeric text. This text is then used as metadata that is associated to the frames of video or whiteboard data content and stored in database 155. This allows a user to perform keyword searches of text terms to retrieve from the database visual content that corresponds to those keywords.

The ability to capture alphanumeric text from captured video is an important feature, as many projected slide presentations will contain text. The platform server does not require the same software that was used to create the slide presentation, and in a typical case such software may not even be present on the server. Thus optical character recognition conversion of the projected images of text allow the content of a text-based slide presentation to be captured for further use, without altering the appearance of the original slide presentation.

### Support for One-to-Many Relationships

In the preceding examples, there has been a one-to-one relationship between a personal device and a peripheral device. That is, one personal device captures and uses one peripheral device at a time. However, the architecture of the platform server is not limited to one-to-one relationships between personal device and peripheral device. The browser screen displayed on each personal device provides a unified access portal through which a single personal device can capture, use and control plural peripheral devices simultaneously. For example, a user might capture the projector for use in giving a slide presentation and also capture the robotic arm to which the projector is attached, in order to change the pointing direction of the projector. Additionally, the same user, using the same personal device, might take control of the room lighting, dimming the lights as appropriate for the presentation. This would thus be an example of a one-to-many relationship, where one personal device simultaneously or concurrently controls many (more than one) smart peripheral devices.

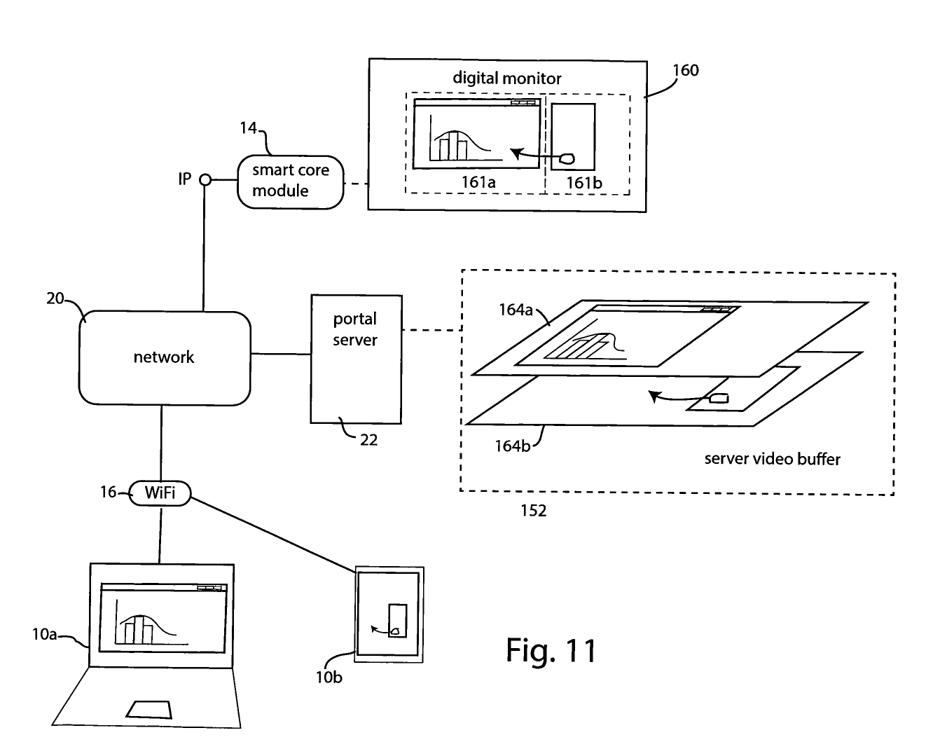

Another form of one-to-many control is illustrated in FIG. 11. In this example, two personal devices, namely, laptop 10a and tablet computer 10b, are simultaneously or concurrently used to capture and present information on the same flat panel digital display monitor 160. In one embodiment, content from the respective devices 10a and 10b is captured and sent to the portal server 22, which then stores the content in separate video buffers within the memory of the server, as depicted diagrammatically at 164a and 164b, respectively. It will be understood that these video buffers may be stored in contiguous or separate portions of the server memory, which is then mapped by the server into different regions on the screen of the digital display monitor, as illustrated diagrammatically at 161a and 161b, respectively.

In one embodiment this mapping is performed such that each region of the screen is dedicated to a different one of the personal devices 10a and 10b. However, in another embodiment, the video buffer memories associated with the devices 10a and 10b (buffers 164a and 164b) are mapped to the entire screen of the digital display, allowing images from one personal device to overlap the image of another. This has been illustrated in FIG. 11, where a portion of the image from device 10b overlaps the image from device 10a. This can be seen in the digital monitor screen 160 where the arrow from device 10b overlays onto the image from device 10a. This overlapping feature allows one user to annotate a presentation given by another user, where such annotation can occur concurrently with the presentation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An interfacing computer system to mediate connections between user devices and peripheral devices, comprising:
a platform server computer having an input/output port that supports communication with a plurality of devices using a predefined protocol, and having at least one processor with associated memory;
the platform server computer programmed to provide a peripheral device registration function whereby information about a peripheral device is stored in the associated memory;
the platform server computer programmed to provide a user device authentication function whereby information about a user device is stored in the associated memory and accessed by the at least one processor to mediate how a registered peripheral device may be accessed by said user device; and
the platform server computer programmed to provide an information routing function whereby source information originating from a first device is routed through the input/output port to a device other than the first device and according to instructions provided to the platform server computer by a user device.

2. The interfacing computer system of claim 1 wherein the platform server computer is programmed to provide a transcoding function whereby said source information communicating through the input/output port is converted into destination information having a protocol different from that of the source information.

3. The interfacing computer system of claim 1 wherein the predefined protocol is the Internet Protocol (IP).

4. The interfacing computer system of claim 1 further comprising a wireless access point coupled to said input/output port that supports communication with said plurality of devices.

5. The interfacing computer system of claim 1 wherein the platform server computer provides a browser interface viewable through a user device.

6. The interfacing computer system of claim 1 wherein the platform server computer is programmed to deliver executable program code to a user device.

7. The interfacing computer system of claim 6 wherein the executable program code causes the user device to capture information from the screen of the user device and send the captured information to the input/output port of the platform server computer.

8. The interfacing computer system of claim 1 wherein the platform server computer is programmed to generate a changing session number that is pushed to a display device located in a room and wherein a user device is authenticated by supplying the session number back to the platform server.

9. The interfacing computer system of claim 1 wherein the peripheral device is a display device and wherein the user device authentication function permits plural user devices to concurrently send information to the display device.

10. The interfacing computer system of claim 9 wherein the display device presents information from said plural user devices, each in separate regions within a display space of the display device.

11. The interfacing computer system of claim 9 wherein the display device presents information from said plural user devices in a manner where an image from one user device overlays an image from another user device.
